(19) United States
(12) Patent Application Publication
(10) Pub. No.: US 2017/0083560 A1
(43) Pub. Date: Mar. 23, 2017

(54) INFORMATION SUPPLY APPARATUS, OPERATION TERMINAL, INFORMATION PROCESSING SYSTEM, AND NON-TRANSITORY COMPUTER READABLE MEDIA

(71) Applicant: FUJI XEROX CO., LTD., Tokyo (JP)

(72) Inventor: Kazutoshi IKEDA, Kanagawa (JP)

(73) Assignee: FUJI XEROX CO., LTD., Tokyo (JP)

(21) Appl. No.: 15/013,133

(22) Filed: Feb. 2, 2016

(30) Foreign Application Priority Data
Sep. 18, 2015 (JP) 2015-185707

(51) Int. Cl. G06F 17/30

(52) U.S. Cl. CPC G06F 17/30362; G06F 17/30011

(57) ABSTRACT

An information supply apparatus includes a registration unit, a setting unit, and a supply unit. The registration unit registers a first document and a second document in a database in association with each other when the second document is derived from the first document. The setting unit refers to the database and sets restraint information indicating restraint on one or more operations among operations performed on the second document, in accordance with restraint information set for the first document. The supply unit supplies, in a case where an operation terminal transmits a request for restraint information indicating restraint on an operation performed on a document, the operation terminal with the restraint information set for the document by the setting unit, the operation terminal restraining, in accordance with the restraint information, the operation performed on the document.

### CROSS-REFERENCE TO RELATED APPLICATIONS

This application is based on and claims priority under 35 USC 119 from Japanese Patent Application No. 2015-185707 filed Sep. 18, 2015.

### BACKGROUND

### Technical Field

The present invention relates to an information supply apparatus, an operation terminal, an information processing system, and non-transitory computer readable media.

### SUMMARY

According to an aspect of the invention, there is provided an information supply apparatus including a registration unit, a setting unit, and a supply unit. The registration unit registers a first document and a second document in a database in association with each other when the second document is derived from the first document. The setting unit refers to the database and sets restraint information indicating restraint on one or more operations among operations performed on the second document, in accordance with restraint information set for the first document. The supply unit supplies, in a case where an operation terminal transmits a request for restraint information indicating restraint on an operation performed on a document, the operation terminal with the restraint information set for the document by the setting unit, the operation terminal restraining, in accordance with the restraint information, the operation performed on the document.

### BRIEF DESCRIPTION OF THE DRAWINGS

An exemplary embodiment of the present invention will be described in detail based on the following figures, wherein:

FIG. 1 is a schematic diagram illustrating an information processing system according to the exemplary embodiment of the invention;

FIG. 2 is a diagram illustrating the configuration of an operation terminal;

FIG. 3 is a diagram illustrating an example of the configurations of documents;

FIG. 4 is a diagram illustrating an example of the configuration of an information supply apparatus;

FIG. 5 is a table illustrating an example structure of a derivation database (DB);

FIG. 6 is a diagram illustrating a derivation relationship among documents in the derivation DB illustrated in FIG. 5;

FIG. 7 is a diagram illustrating an example structure of a restraint DB;

FIG. 8 is a table illustrating an example structure of an inheritance rule base (RB);

FIG. 9 is a diagram illustrating the functional configuration of the information processing system;

FIG. 10 is a sequence diagram illustrating a root registration process performed in the information processing system;

FIG. 11 is a sequence diagram illustrating a restraint acquisition process performed in the information processing system;

FIG. 12 is a sequence diagram illustrating a child registration process performed in the information processing system;

FIG. 13 is a sequence diagram illustrating a restraint change process performed in the information processing system;

FIG. 14 is a flowchart illustrating how the information supply apparatus changes restraint information;

FIG. 15 is a sequence diagram illustrating a deletion process performed in the information processing system; and

FIG. 16 is a flowchart illustrating how the information supply apparatus locates and supplies the restraint information.

### DETAILED DESCRIPTION

### 1. Exemplary Embodiment

### 1-1. Configuration of Information Processing System

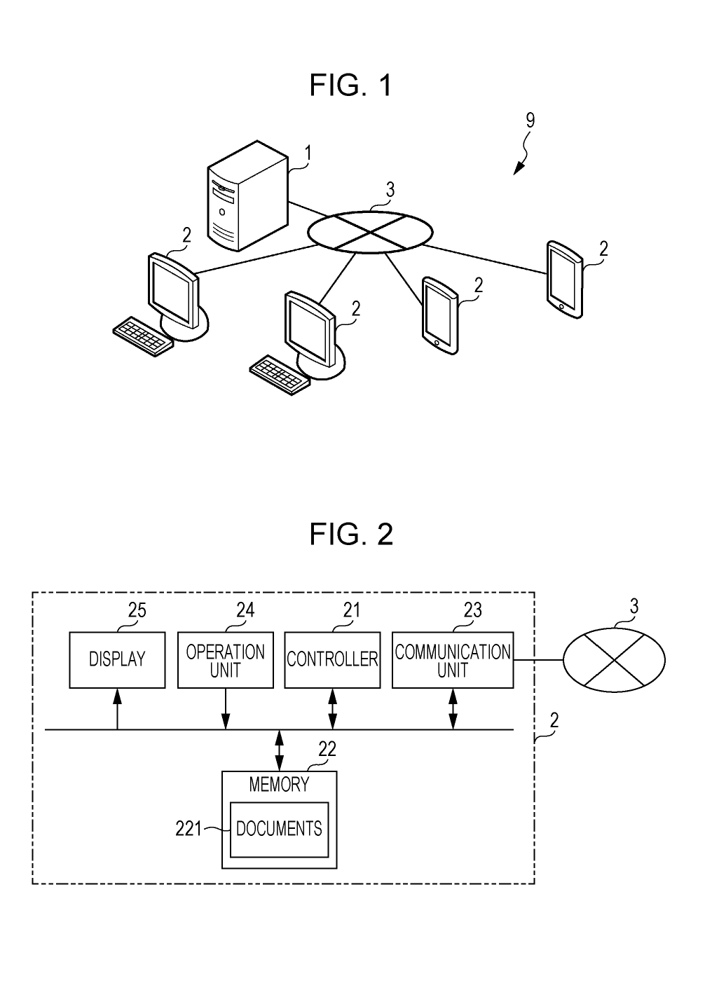

FIG. 1 is a schematic diagram illustrating an information processing system 9 according to an exemplary embodiment of the invention. The information processing system 9 includes an information supply apparatus 1 and operation terminals 2. The information supply apparatus 1 is connected to each operation terminal 2 through a communication network 3. The communication network 3 is a public network through which communications between the information supply apparatus 1 and the operation terminal 2 are performed. The communication network 3 is, for example, the Internet. Note that a dedicated network instead of the public network may be used as the communication network 3.

As illustrated in FIG. 1, multiple operation terminals 2 may be used. Multiple information supply apparatuses 1 may also be used but need to be synchronized with each other for unified restraint information management.

Each operation terminal 2 is a terminal for performing operations on a document. The information supply apparatus 1 is a server apparatus that registers a derivation relationship between a document generated by the operation terminal 2 and a new document derived from the document and that determines, in accordance with the derivation relationship, how operations performed on the documents by using the operation terminal 2 are restrained. The information processing system 9 is a collaborative document generation system by which multiple users of the respective operation terminals 2 each generate a document in accordance with document restraint managed by the information supply apparatus 1, derive a document from the original document, and exchange the derived document.

### 1-2. Configuration of Operation Terminal

FIG. 2 is a diagram illustrating the configuration of each operation terminal 2. The operation terminal 2 includes a controller 21, a memory 22, a communication unit 23, an operation unit 24, and a display 25.

The controller 21 includes a computing device such as a central processing unit (CPU) and main memories such as a read-only memory (ROM) and a random-access memory (RAM). The computing device controls operations of the components of the operation terminal 2 by running programs stored in the ROM and the memory 22 by using the RAM as a work area.

The communication unit 23 is an interface for communication with the information supply apparatus 1 and any one of the operation terminals 2 through the communication network 3.

The memory 22 is a memory such as a hard disk or a solid state drive and is used to store data and programs used by the controller 21. The memory 22 is used to store documents generated and derived using the operation terminal 2.

The operation unit 24 includes a touch panel and an operator, the touch panel being used to detect the location where a designation body such as a finger of a user touches and to identify the user's designation, the operator including operation buttons for the user's designations. The operation unit 24 receives an operation performed by the user and supplies a signal corresponding to the content of the operation to the controller 21.

The display 25 has a liquid crystal display and displays various pieces of information designated by the controller 21. The touch panel of the operation unit 24 may be disposed on the display 25. In this case, the touch panel is made of a transparent material to enable the user to see images displayed on the liquid crystal display of the display 25.

### 1-3. Configuration of Documents

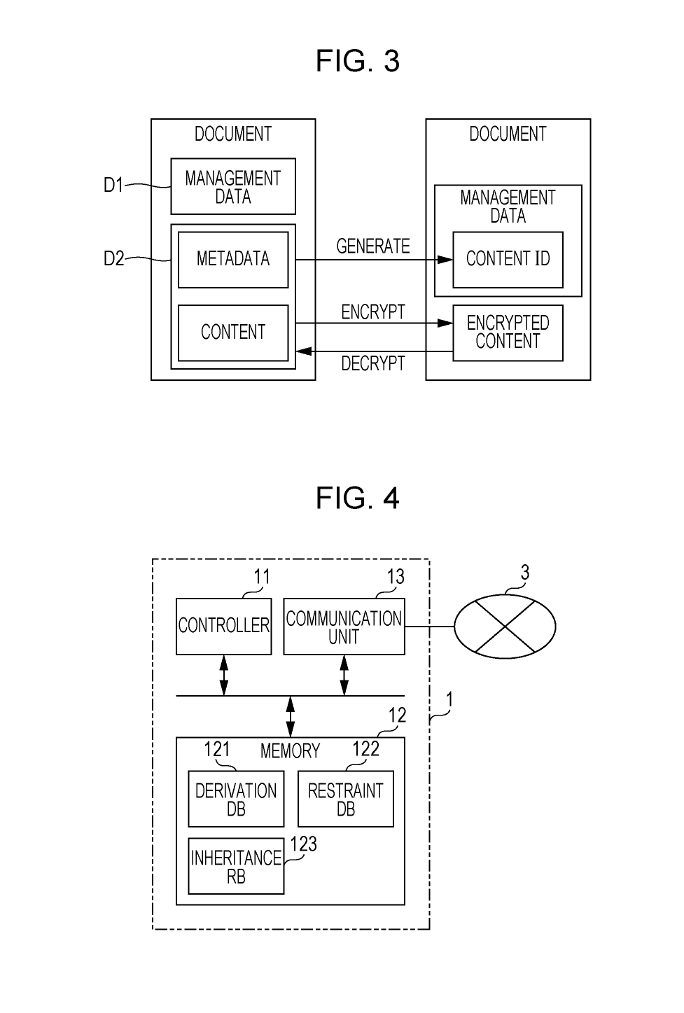

FIG. 3 is a diagram illustrating an example of the configurations of documents. Each document handled by the operation terminal 2 has management data D1 and body data D2 as illustrated in, for example, FIG. 3. The management data D1 is used by the operating system for document management and denotes a file name, a generation date and time, an update date and time, a storage location, and the like. The body data D2 is used by a program run in the operation terminal 2 by the controller 21.

The body data D2 includes metadata and content. The content is what the document contains. The metadata is data that is not included in the content and is assigned to the body data D2 by the program to discriminate the content from the content of another document. The operation terminal 2 uses, for example, a universally unique identifier (UUID) for the metadata.

The operation terminal 2 generates a content ID as identification information uniquely identifying body data. Specifically, the operation terminal 2 generates a content ID by using a cryptographic hash function such as MD5 or SHA-256. Note that when pieces of body data respectively have identical pieces of content but different pieces of metadata, different content IDs are generated for the respective pieces of content. In addition, when the operating system duplicates a document, a new document obtained as the result of duplication has metadata and content that are the same as those of the original document, respectively, but has different management data D1. When a content ID is generated for this new document, the new document has the same content ID as that of the original document because the new document has the metadata and content that are the same as those of the original document.

The operation terminal 2 encrypts body data by using an encryption key to generate encrypted content and decrypts the encrypted content by using a decryption key to generate the original body data. A common key may be used as the encryption key and the decryption key.

When encrypting a document, the operation terminal 2 includes, in the document, the encrypted content and the management data including a content ID generated on the basis of the body data. The encrypted content is thereby associated with the content ID.

### 1-4. Configuration of Information Supply Apparatus

FIG. 4 is a diagram illustrating an example of the configuration of the information supply apparatus 1. The information supply apparatus 1 includes a controller 11, a memory 12, and a communication unit 13. The controller 11 includes a computing device such as a CPU and main memories such as a ROM and a RAM. The computing device controls operations of the components of the information supply apparatus 1 by running programs stored in the ROM and the memory 12 by using the RAM as a work area. The communication unit 13 is an interface for communication with the operation terminal 2 through the communication network 3. The memory 12 is a memory such as a hard disk and is used to store data and programs used by the controller 11. The memory 12 is also used to store a derivation database (DB) 121, a restraint DB 122, and an inheritance rule base (RB) 123.

### 1-5. Structure of Derivation DB

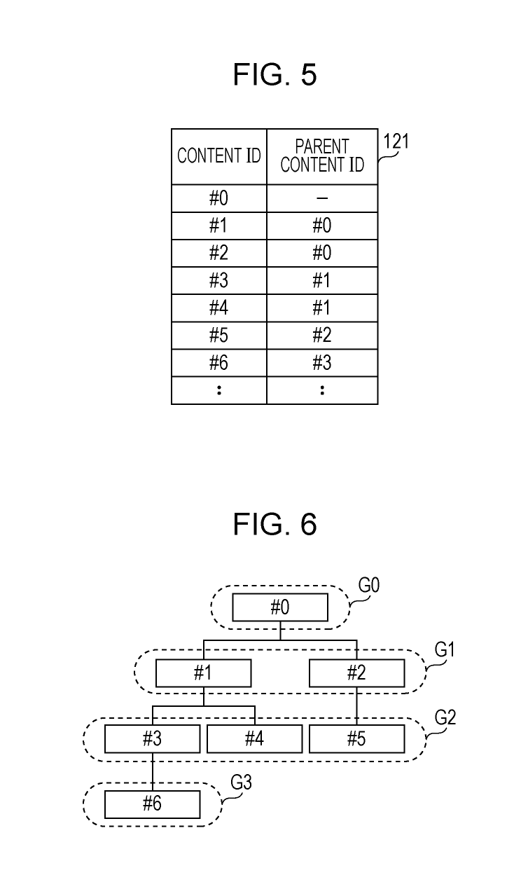

FIG. 5 is a table illustrating an example structure of the derivation DB 121. The derivation DB 121 is used to associate a document (first document) with another document (second document) when the second document is derived from the first document. Specifically, the derivation DB 121 is used to store the content ID of the first document and the content ID of the second document in association with each other.

The first document is a document that is the original, in other words, the “parent” of the second document, and a content ID identifying the first document is described as a “parent content ID” in the derivation DB 121. Note that the content of a document that has not been derived from any document is referred to as “root content”. Since a document having the root content is not derived from any document, a corresponding “parent content ID” field in the derivation DB 121 has data indicating “absence”, for example, “-”.

FIG. 6 is a diagram illustrating a derivation relationship among documents in the derivation DB 121 illustrated in FIG. 5. In FIG. 6, each document is represented by the content ID of content of the document. A document #0 having root content is not derived from any document and thus belongs to a zeroth generation G0 resulting from derivation performed zero times. Documents #1 and #2 that are derived from the document #0 belong to a first generation G1 resulting from derivation performed one time.

Documents #3 and #4 that are derived from the document #1 belong to a second generation G2 resulting from derivation performed two times. A document #5 derived from the document #2 also results from derivation performed two times and thus belongs to the second generation G2. A document #6 derived from the document #3 belongs to the third generation G3 resulting from derivation performed three times.

In other words, with reference to the derivation DB 121, each document having the corresponding content ID registered in the derivation DB 121 is classified based on the number of times derivation is performed from the root content.

### 1-6. Structure of Restraint DB

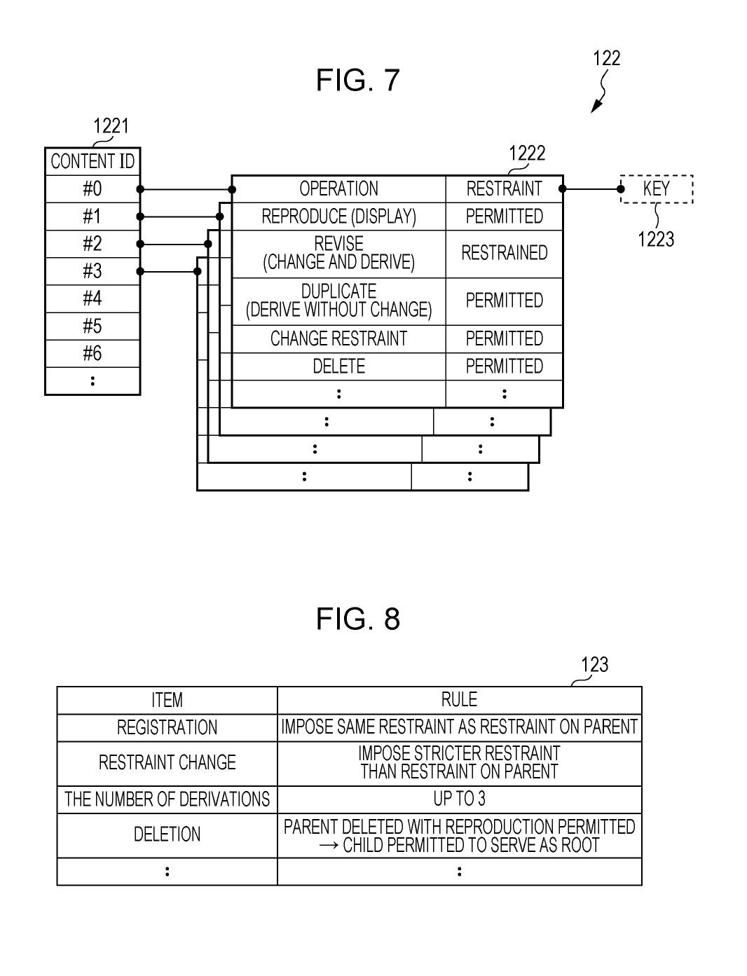

FIG. 7 is a diagram illustrating an example structure of the restraint DB 122. The restraint DB 122 is used to store restraint on operations performed on a document having content identified by a content ID. The restraint DB 122 is used to store a content ID list 1221, restraint information 1222, and keys 1223. Each piece of data in the content ID list 1221 is associated with the corresponding piece of restraint information 1222 and the corresponding key 1223.

The content ID list 1221 lists the content IDs registered in the derivation DB 121, and each content ID is associated with the corresponding piece of restraint information 1222. Each piece of restraint information 1222 indicates restraint on one or more operations among operations performed on the corresponding document having the content identified by the content ID, and each operation in an operation column is associated with whether to restrain the operation.

For example, for content having the content ID #0, an operation of “Reproduce (display)” is associated with “Permitted”. This indicates that a reproducing operation performed on the content having the content ID #0 is permitted. In contrast, for the content having the content ID #0, an operation of “Revise (change and derive)” is associated with “Restrained”. This indicates that an operation of revising the content having the content ID #0 by changing the content and then by deriving another piece of content is not permitted.

Note that reproduction of content corresponds to a process of making the content perceivable by a user. For example, in a case where the content of a document is expressed using a string or an image, reproduction of the content may correspond to displaying the content. In a case where the content is expressed using sound, the reproduction of the content may correspond to sound emission. In a case where the content is expressed using video, the reproduction of the content may correspond to projection or the like of the content accompanied by sound emission.

The key 1223 is stored in association with a content ID of content reproduction of which is not restrained in the restraint information 1222. The key 1223 is a common key used when content and metadata are encrypted to generate encrypted content and when the encrypted content is decrypted.

### 1-7. Structure of Inherence RB

FIG. 8 is a table illustrating an example structure of the inheritance RB 123. The inheritance RB 123 is used to store rules for a second document to inherit restraint information from a first document when the second document is derived from the first document. In such a case where restraint information of a document is set, changed, or supplied, the information supply apparatus 1 finds a derivation relationship among the documents by referring to the derivation DB 121 and determines whether the restraint information for the document described in the restraint DB 122 satisfies the rules in the inheritance RB 123.

For example, the inheritance RB 123 describes a rule in which “if the parent (first document) of a document (second document) is present, the same restraint as that on the parent is imposed” at the time of registration of the document (second document). This causes a document to inherit the restraint information of the original when the document is registered. In addition, the inheritance RB 123 describes a rule in which “a restraint stricter than that on the parent is imposed” at the time of “restraint change” in which the restraint information of a document is changed in accordance with an instruction from the operation terminal 2. This leads to permission of performing a smaller number of operations on a second document derived from a first document than operations permitted for the first document.

The inheritance RB 123 also describes a rule for the number of times a new document is derived from a document. In the example in FIG. 8, the rule for “the number of derivations” defines “up to three times”. The number of times a new document is derived from a document, which is counted from the root content, is thereby restrained to three. For example, among the documents illustrated in FIG. 6, the document having the content ID #6 generated as the result of three derivations counted from the document having the content ID #0. Accordingly, it is prohibited to derive a new document from the document having the content ID #6.

The inheritance RB 123 may also describe a rule for deleting a document. The inheritance RB 123 illustrated in FIG. 8 describes permission of causing a child (second document) to serve as a root in a case where a parent (first document) for which reproduction is not restrained (with reproduction permitted) is deleted. The term “causing content to serve as a root” denotes changing the registration of content, in the information supply apparatus 1, to registration as “root content” that is not derived from any content. According to this rule, the content of the second document derived from the first document for which reproduction is not restrained serves as the root content when the first document is deleted. Note that the inheritance RB 123 may describe a rule in which when a first document for which reproduction is restrained is deleted, the content of a second document derived from the first document is also deleted.

### 1-8. Functional Configuration of Information Processing System

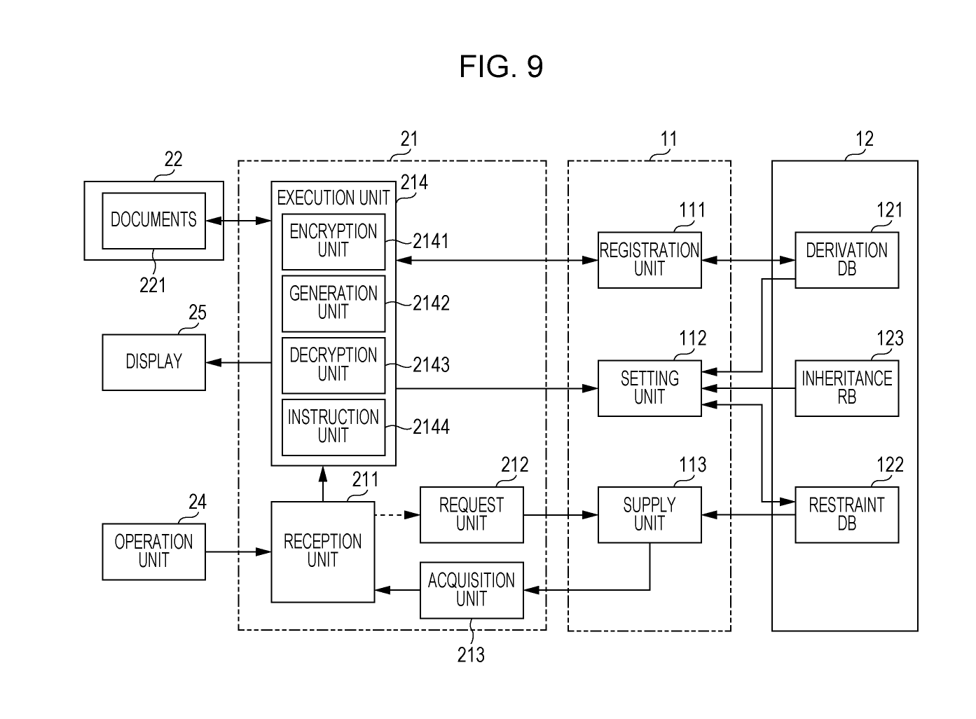

FIG. 9 is a diagram illustrating the functional configuration of the information processing system 9. In FIG. 9, the communication unit 13 of the information supply apparatus 1, the communication unit 23 of the operation terminal 2, and the communication network 3 are omitted.

The controller 11 of the information supply apparatus 1 functions as a registration unit 111, a setting unit 112, and a supply unit 113 by running programs stored in the memory 12. The controller 21 of the operation terminal 2 functions as a reception unit 211, a request unit 212, an acquisition unit 213, and an execution unit 214 by running programs stored in the memory 22.

When a second document is derived from a first document, the registration unit 111 registers the first document and the second document in the derivation DB 121 in association with each other. The setting unit 112 refers to the derivation DB 121 and sets, in accordance with restraint information set for the first document, restraint information indicating restraint on one or more operations among operations performed on the second document. At this time, the setting unit 112 sets the restraint information for the second document so as to satisfy rules in the inheritance RB 123. When the operation terminal 2 requests restraint information set for a document, the supply unit 113 supplies the operation terminal 2 with restraint information set for the document by the setting unit 112.

The request unit 212 requests the information supply apparatus 1 for restraint information indicating restraint on one or more operations among operations performed on a document selected by a user by using the operation unit 24. The acquisition unit 213 acquires the restraint information supplied from the information supply apparatus 1 in response to the request from the request unit 212. Among the operations performed on the document, the reception unit 211 receives an operation that is not restrained in the restraint information acquired by the acquisition unit 213. The execution unit 214 performs information processing on the document in accordance with the operation received by the reception unit 211.

The execution unit 214 executes various information processing operations in accordance with a user operation and includes, for example, an encryption unit 2141, a generation unit 2142, a decryption unit 2143, and an instruction unit 2144. The encryption unit 2141 encrypts the content and the metadata of a document stored in documents 221 and generates encrypted content. The generation unit 2142 generates a content ID from the content and the metadata of the document. The decryption unit 2143 decrypts the encrypted content to generate the original content and the original metadata. For example, in a case where an operation such as reproduction, revision, or duplication in the operation received by the reception unit 211 needs decryption of a document, the decryption unit 2143 decrypts the document. The instruction unit 2144 instructs the display 25 of the operation terminal 2 or the information supply apparatus 1 to perform corresponding processing for the operation received by the reception unit 211.

### 1-9. Operations of Information Processing System

The information processing system 9 performs a root registration process, a restraint acquisition process, a child registration process, a restraint change process, and a deletion process. Hereinafter, operations in the processes will be described.

### (1) Root Registration Process

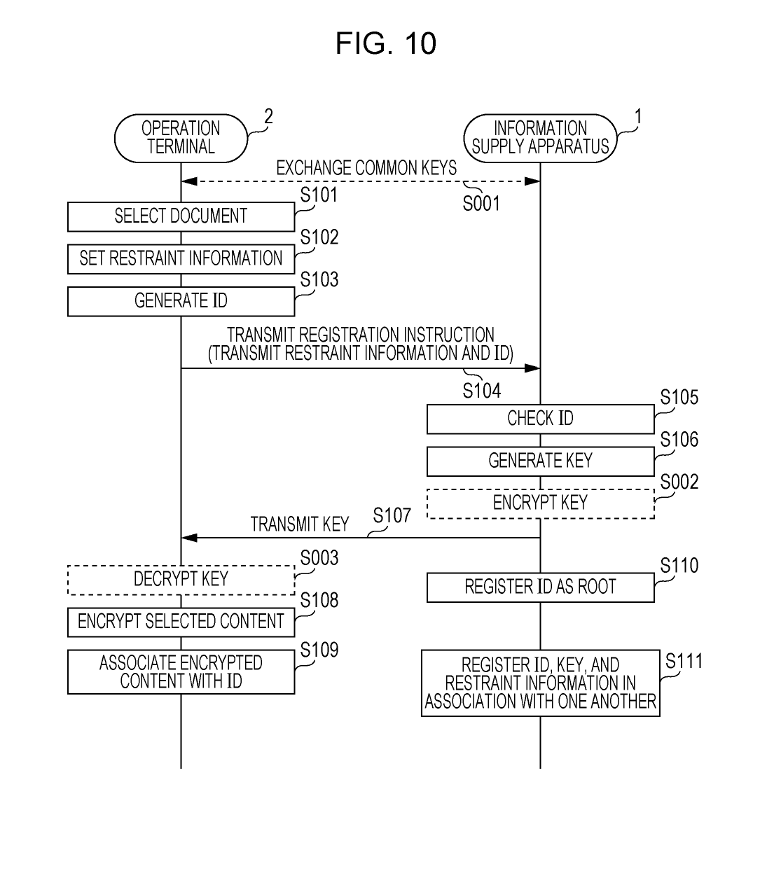

FIG. 10 is a sequence diagram illustrating a root registration process performed in the information processing system 9. The operation terminal 2 and the information supply apparatus 1 exchange common keys by using a key exchange system such as Diffie-Hellman key exchange (step S001). In case that information exchanged through the communication network 3 connecting the operation terminal 2 and the information supply apparatus 1 is wiretapped, the content of communication is encrypted by using the exchanged common keys and is thus protected.

The operation terminal 2 selects a document in accordance with an instruction from the user (step S101) and sets restraint information for the document (step S102). The operation terminal 2 subsequently generates a content ID from content and metadata included in the document by using the aforementioned cryptographic hash function or the like (step S103). The operation terminal 2 transmits the content ID and the restraint information to the information supply apparatus 1 and instructs the information supply apparatus 1 to register content indicated by the content ID as root content (step S104).

Upon receiving the registration instruction transmitted from the operation terminal 2, the information supply apparatus 1 checks whether the content ID included in the instruction has been stored in the derivation DB 121 (step S105). If the content ID included in the instruction has been stored in the derivation DB 121, the information supply apparatus 1 notifies the operation terminal 2 that the content ID has already been registered. However in this case, the content ID has not been stored in the derivation DB 121, and the information supply apparatus 1 thus generates a key for the content indicated by the content ID (step S106).

The information supply apparatus 1 encrypts the generated key by using the corresponding common key obtained in step S001 (step S002) and transmits the encrypted key to the operation terminal 2 (step S107).

The operation terminal 2 acquires the encrypted key transmitted from the information supply apparatus 1. The operation terminal 2 subsequently decrypts the acquired key by using the corresponding common key obtained in step S001 and generates the original key (step S003). By using the decrypted key, the operation terminal 2 encrypts the content and the metadata of the document selected in step S101 and generates encrypted content (step S108). The operation terminal 2 subsequently stores the encrypted and generated content, as a document in the memory 22 in association with a content ID (step S109).

The information supply apparatus 1 registers the content ID indicated by the registration instruction transmitted from the operation terminal 2, as the content ID of root content in the derivation DB 121 (step S110). The information supply apparatus 1 subsequently registers the content ID, the key generated in step S106, and restraint information indicated by the instruction in association with one another in the restraint DB 122 (step S111).

Note that the processes in steps S001, S002, and S003 described above are each an “encrypted communication process” for exchanging encrypted information by using a public network. Accordingly, in a case where there is no risk in wiretapping such as a case where a dedicated network is used, the processes in steps S001, S002, and S003 do not have to be performed. In the following sequence diagrams, descriptions of the encrypted communication processes are omitted.

### (2) Restraint Acquisition Process

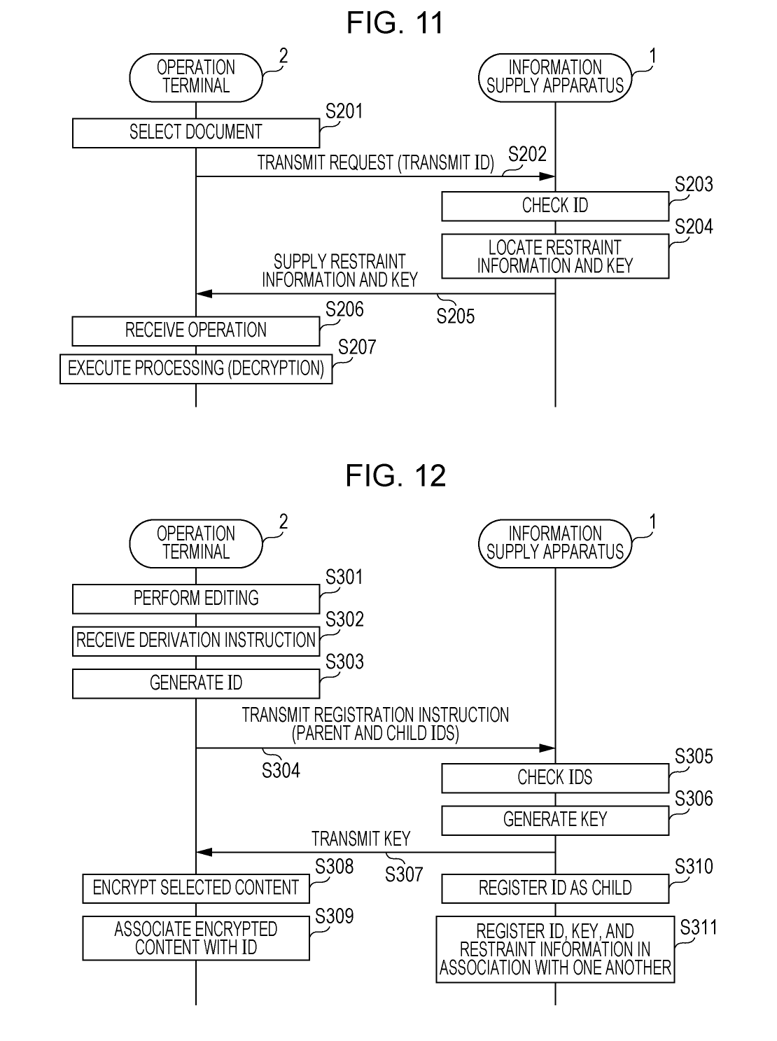

FIG. 11 is a sequence diagram illustrating the restraint acquisition process performed in the information processing system 9. The operation terminal 2 selects a document in accordance with an instruction from the user (step S201). The operation terminal 2 requests the information supply apparatus 1 for restraint information set for the document, by using a content ID included in the management data D1 in the document (step S202).

Upon receiving the request for the restraint information from the operation terminal 2, the information supply apparatus 1 checks the content ID included in the request against the content IDs in the restraint DB 122 (step S203) and locates restraint information 1222 and a key 1223 that are associated with the content ID (step S204). The information supply apparatus 1 supplies the operation terminal 2 with the pieces of information thus located (step S205).

Upon acquiring the restraint information 1222 associated with the content ID, the operation terminal 2 receives an operation that is not restrained in the acquired restraint information 1222 among operations performed on the document having the content identified by the content ID (step S206). For example, the operation terminal 2 may display an operation restrained in the restraint information 1222 on the display 25 in such a manner as to perform so-called “gray-out” on a button for the operation.

In accordance with the operation received in step S206, the operation terminal 2 performs processing on the document (step S207). For example, in a case where the received operation needs decryption of the content (encrypted content) of the document, the operation terminal 2 decrypts the content.

### (3) Child Registration Process

FIG. 12 is a sequence diagram illustrating the child registration process performed in the information processing system 9. In a case where “Revise” that is an operation of deriving a new document having content resulting from change of content of a specific document is permitted (that is, not restrained), the operation terminal 2 performs editing for generating the new content in accordance with an instruction from the user (step S301). In a case where the user gives an instruction for deriving a document on the basis of the edited content, the operation terminal 2 subsequently receives the instruction (step S302) and generates a content ID from body data D2 having the edited content and the metadata (step S303). Thereafter, the operation terminal 2 associates the generated content ID with a content ID included in the management data D1 of the original document, that is, a “parent content ID”, transmits the content IDs to the information supply apparatus 1, and instructs the information supply apparatus 1 to register the new document (step S304).

The information supply apparatus 1 checks a combination of the generated content ID (referred to as a child content ID) and the parent content ID against combinations in the derivation DB 121 (step S305). If the check results in a determination that the parent content ID has been registered in the derivation DB 121 and that the child content ID has not been registered in the derivation DB 121, the information supply apparatus 1 generates a key for storing the child content in association with the child content ID (step S306) and transmits the key to the operation terminal 2 (step S307).

Even though the content is not changed in the editing in step S301, the operation terminal 2 generates metadata every time an operation is performed. Accordingly, the editing results in a different combination of content and metadata. A content ID generated from the content and the metadata after editing is different from a content ID before editing.

Upon acquiring the key transmitted from the information supply apparatus 1, the operation terminal 2 uses the key to encrypt the selected content and the metadata of the document edited in step S301 and generates encrypted content (step S308). The operation terminal 2 subsequently associates the encrypted content thus generated with the child content ID and stores the document in the memory 22 (step S309).

The information supply apparatus 1 registers the child content ID indicated by the registration instruction transmitted from the operation terminal 2, in the derivation DB 121 in association with the parent content ID (step S310). The child content ID is thereby registered in the derivation DB 121 as a content ID of the content of the new document derived from the original document having the content identified by the parent content ID. In other words, a second document having the content identified by the child content ID is registered as a child of a first document having the content identified by the parent content ID.

The information supply apparatus 1 subsequently associates the child content ID with the key generated in step S306 and default restraint information and registers the child content ID, the key, and the restraint information in the restraint DB 122 (step S311). The default restraint information registered in the restraint DB 122 is generated based on the restraint information set for the first document and the inheritance RB 123. Specifically, the default restraint information is, for example, information obtained by duplicating the restraint information used for a first document without any change.

### (4) Restraint Change Process

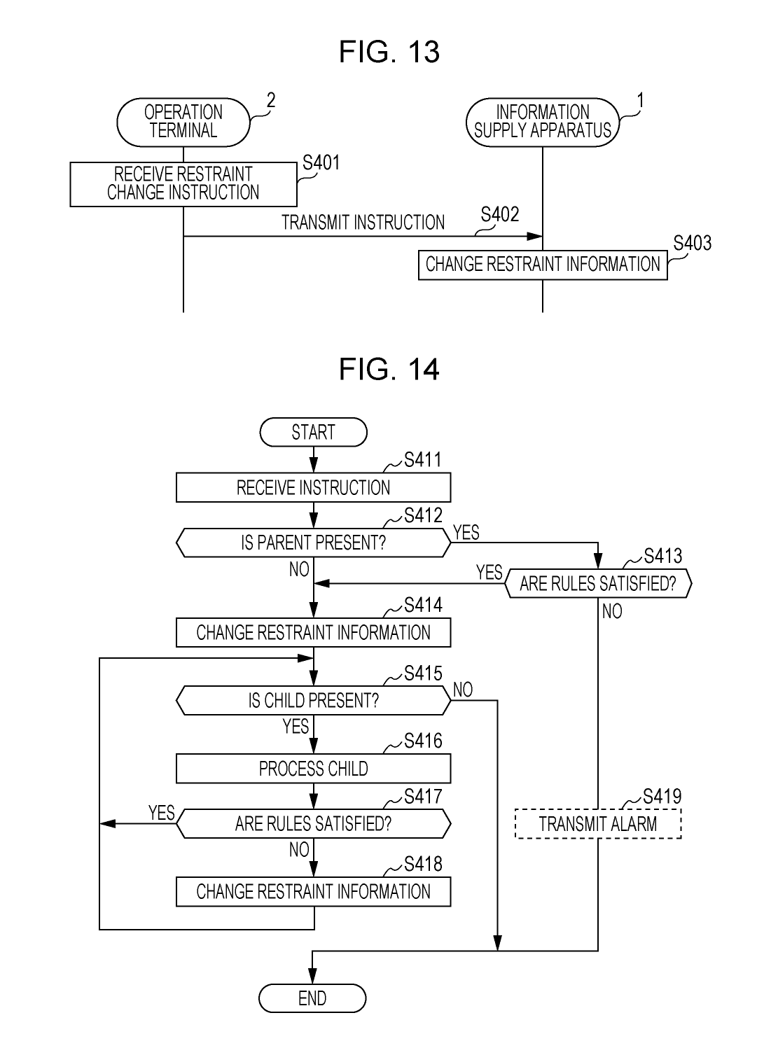

FIG. 13 is a sequence diagram illustrating the restraint change process performed in the information processing system 9. After receiving an instruction from the user for changing the restraint information of a selected document (step S401), the operation terminal 2 instructs the information supply apparatus 1 to change the restraint information in accordance with the instruction from the user (step S402).

Upon receiving the instruction for changing the restraint information of the document from the operation terminal 2, the information supply apparatus 1 refers to the derivation DB 121 and checks whether the original document (a document serving as a parent) of the selected document is present and determines whether the restraint information to result from the change instructed using the instruction satisfies the corresponding rules described in the inheritance RB 123 in the derivation relationship. If the restraint information satisfies the rules, the information supply apparatus 1 changes the restraint information in accordance with the instruction (step S403).

FIG. 14 is a flowchart illustrating how the information supply apparatus 1 changes restraint information. After receiving an instruction for changing restraint information from the operation terminal 2 (step S411), the information supply apparatus 1 determines whether the parent (the original document) of a designated document is present (step S412). If the information supply apparatus 1 determines that the parent is present (YES in step S412), the information supply apparatus 1 determines whether restraint information to result from the change made in accordance with the instruction satisfies the corresponding rules described in the inheritance RB 123 in the relationship between restraint information set for the parent and the resultant restraint information (step S413). If the information supply apparatus 1 does not determine that the resultant restraint information satisfies the corresponding rules in the relationship (NO in step S413), the information supply apparatus 1 terminates the process. At this time, the information supply apparatus 1 may transmit, to the operation terminal 2, an alarm indicating that the resultant restraint information does not satisfy the rules (step S419).

If the information supply apparatus 1 does not determine that the parent is present (NO in step S412), and if the information supply apparatus 1 determines that restraint information to result from the change made in accordance with the instruction satisfies the corresponding rules described in the inheritance RB 123 in the relationship between restraint information set for the parent and the resultant restraint information (YES in step S413), the information supply apparatus 1 performs the change on the restraint information in accordance with the instruction (step S414).

After performing the change in accordance with the instruction, the information supply apparatus 1 determines whether a document derived from the designated document, that is, a “child” is present (step S415). If the information supply apparatus 1 does not determine that a child is present (NO in step S415), the information supply apparatus 1 terminates the process.

If the information supply apparatus 1 determines that a child is present (YES in step S415), the information supply apparatus 1 processes the child (step S416). The information supply apparatus 1 subsequently determines whether the restraint information of a second document that is the child satisfies the corresponding rules described in the inheritance RB 123 in the relationship with a first document that is the parent (step S417).

If the information supply apparatus 1 determines that the restraint information of the second document satisfies the rules in the relationship with the first document (YES in step S417), the information supply apparatus 1 moves the process back to step S415. In contrast, if the information supply apparatus 1 does not determine that the restraint information of the second document satisfies the rules in the relationship with the first document (NO in step S417), the information supply apparatus 1 changes the restraint information for the second document that is a process target on the basis of the restraint information set for the first document and the rules described in the inheritance RB 123 (step S418) and thereafter moves the process back to step S415. This serially verifies the rules for inheritance to a derived generation until a process target does not have a child any more and changes the restraint information so as to satisfy the rules.

### (5) Deletion Process

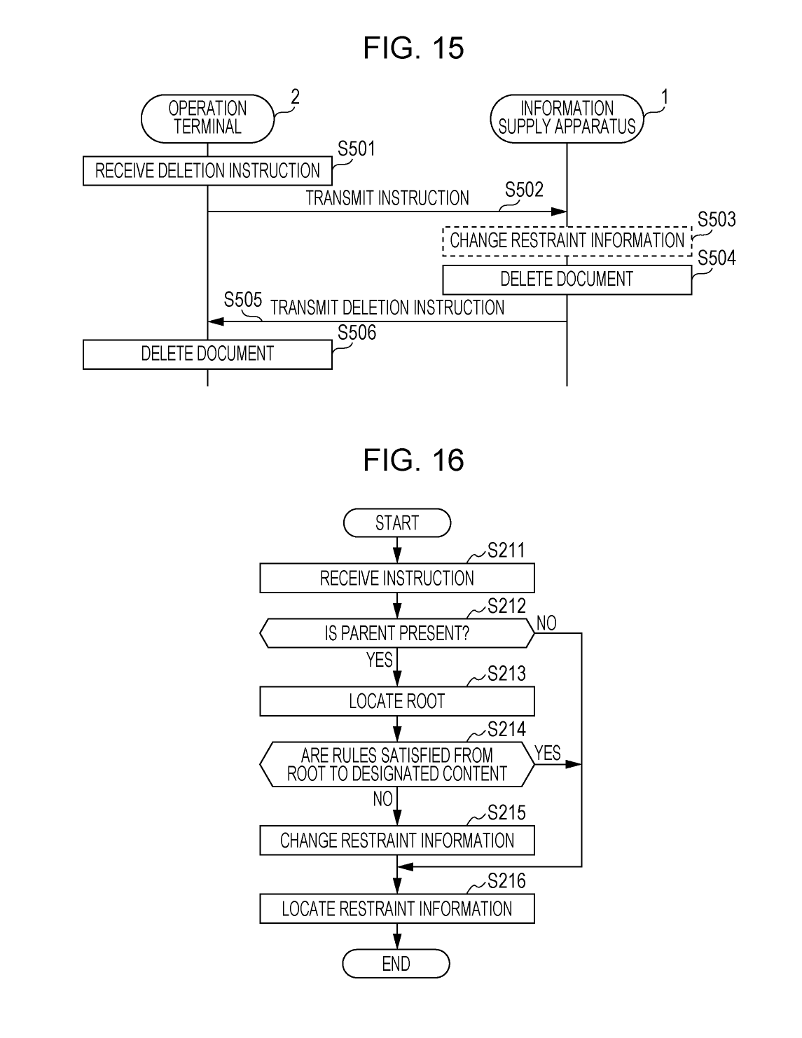

FIG. 15 is a sequence diagram illustrating a deletion process performed in the information processing system 9. After receiving an instruction for deleting a selected document from the user (step S501), the operation terminal 2 instructs the information supply apparatus 1 to delete the document in accordance with the instruction (step S502).

The information supply apparatus 1 receives the instruction for deleting the document from the operation terminal 2. If this instruction indicates that the restraint information of the document is to be changed and the document is thereafter to be deleted, the information supply apparatus 1 changes the restraint information in accordance with the instruction (step S503). If there is a document derived from the designated document, the information supply apparatus 1 changes the restraint information of the designated and derived documents so as to satisfy the rules described in the inheritance RB 123.

The information supply apparatus 1 subsequently deletes the designated document (step S504). Specifically, the information supply apparatus 1 deletes the content ID of the content of the designated document from the derivation DB 121 and changes the corresponding parent content ID to “-”.

In addition, the information supply apparatus 1 deletes the content ID of the content of the designated document from the content ID list 1221 in the restraint DB 122 and deletes the restraint information 1222 and the key 1223 that are associated with the content ID.

After deleting the content ID of the designated document in the information supply apparatus 1, the information supply apparatus 1 also instructs the operation terminal 2 to delete the document (step S505). In response to the instruction, the operation terminal 2 deletes the designated document from the documents 221 in the memory 22 (step S506).

As described above, the information supply apparatus 1 manages the derivation relationship among the documents (a parent-child relationship) in the information processing system 9. Accordingly, even though multiple documents are stored in the operation terminals 2 separately, the derivation relationship among the documents may be checked through any one of the operation terminals 2. In addition, restraint information set for a second document derived from a first document is set in accordance with restraint information set for the first document. Accordingly, when an operator of the first document restrains an operation performed on a second document, the operator of the first document neither needs to identify an operator of the second document nor trace how the operator of the second document acquires the second document.

### 2. Modifications

The exemplary embodiment has heretofore been described but may be modified as follows. In addition, the following modifications may be combined.

### 2-1. Modification 1

In the exemplary embodiment described above, when the information supply apparatus 1 receives, from the operation terminal 2, an instruction for changing the restraint information of a selected document, the information supply apparatus 1 determines whether the rules in the inheritance RB 123 are satisfied in the relationship between the selected document and the original document (parent) of the selected document and whether the rules in the inheritance RB 123 are satisfied in the relationship between the selected document and a document derived from the selected document (child). However, the determination timing is not limited thereto. For example, when the operation terminal 2 requests the restraint information, the information supply apparatus 1 may perform the aforementioned determination.

FIG. 16 is a flowchart illustrating how the information supply apparatus 1 locates and supplies the restraint information. After receiving an instruction from the operation terminal 2 (step S211), the information supply apparatus 1 determines whether the parent (the original document) of a designated document is present (step S212).

If the information supply apparatus 1 does not determine that the parent is present (NO in step S212), the information supply apparatus 1 moves the process to step S216. If the information supply apparatus 1 determines that the parent is present (YES in step S212), the information supply apparatus 1 goes back to the original of the designated document and further the original of the original of the designated document and thereby locates the root content (step S213). The information supply apparatus 1 subsequently determines whether the rules described in the inheritance RB 123 are satisfied in each derivation relationship in the course from the root content to the content of the designated document (step S214).

If the information supply apparatus 1 determines that the rules described in the inheritance RB 123 are satisfied in each derivation relationship (YES in step S214), the information supply apparatus 1 moves the process to step S216. If the information supply apparatus 1 does not determine that the rules described in the inheritance RB 123 are satisfied in each derivation relationship (NO in step S214), the information supply apparatus 1 changes the restraint information of the corresponding derived document on the basis of the restraint information of the original document so as to satisfy the rules (step S215) and moves the process to step S216. After performing the process up to step S215, the information supply apparatus 1 locates the restraint information of the designated document (step S216). The located restraint information is supplied to the operation terminal 2.

### 2-2. Modification 2

In the exemplary embodiment described above, a smaller number of operations are permitted for a second document derived from a first document than operations permitted for the first document. In other words, in the exemplary embodiment, the inheritance RB 123 specifies that the operation terminal 2 restrains a larger number of operations in the restraint information set by the information supply apparatus 1 for the second document derived from the first document than operations restrained in the restraint information set for the first document. However, the rules in the inheritance RB 123 are not limited thereto. The inheritance RB 123 may, for example, specify that the same restraint information is set for the second document derived from the first document and the first document and may specify that restraint information is set so as to restrain a smaller number of operations on the second document than on the first document.

### 2-3. Modification 3

In the exemplary embodiment described above, the information supply apparatus 1 generates a key every time a document is registered, and the operation terminal 2 acquires restraint information set for the document and the key for decrypting the document. However, the key for decrypting a document is not limited thereto. For example, a key does not have to be generated for each document. Specifically, a program run by the operation terminal 2 may describe a common key in advance, and the operation terminal 2 may use the common key to encrypt the content and the metadata of a document and decrypt the content and the metadata from the encrypted content. In this case, note that once the common key is extracted for a specific document, encrypted data from another document is also decrypted. In contrast, the generation of a key for each document as described above does not involve such a risk.

Note that the information processing system 9 does not have to encrypt a document. For example, the operating system may restrain application programs in the operation terminal 2 to allow only a predetermined application program to handle documents. In this case, the application program may transmit a second document derived from a first document to another operation terminal 2. The transmission may be set as an operation in the operation column of the restraint DB 122.

### 2-4. Modification 4

The program run by the controller 11 of the information supply apparatus 1 may be provided in such a manner as to be stored in a computer readable recording medium, for example, a magnetic recording medium such as a magnetic disk or a magnetic tape, an optical recording medium such as an optical disk, a magneto-optical recording medium, or a semiconductor memory. The program may be downloaded through a communication network such as the Internet. Note that various devices in addition to the CPU are applicable to a controller exemplified by the aforementioned controller 11 in some cases, and, for example, a dedicated processor or the like is used.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information supply apparatus comprising:
a registration unit that registers a first document and a second document in a database in association with each other when the second document is derived from the first document;
a setting unit that refers to the database and sets restraint information indicating restraint on one or more operations among operations performed on the second document, in accordance with restraint information set for the first document; and
a supply unit that supplies, in a case where an operation terminal transmits a request for restraint information indicating restraint on an operation performed on a document, the operation terminal with the restraint information set for the document by the setting unit, the operation terminal restraining, in accordance with the restraint information, the operation performed on the document.

2. The information supply apparatus according to claim 1,
wherein the restraint information set for the second document by the setting unit causes the operation terminal to restrain a larger number of operations performed on the second document than operations restrained in accordance with the restraint information set for the first document.

3. The information supply apparatus according to claim 1,
wherein the setting unit sets restraint information regarding an operation of deriving a new document from the second document.

4. The information supply apparatus according to claim 2,
wherein the setting unit sets restraint information regarding an operation of deriving a new document from the second document.

5. The information supply apparatus according to claim 3,
wherein the setting unit sets restraint information regarding the number of times the operation of deriving a new document from the second document is performed.

6. The information supply apparatus according to claim 4,
wherein the setting unit sets restraint information regarding the number of times the operation of deriving a new document from the second document is performed.

7. The information supply apparatus according to claim 1,
wherein the document has been encrypted, and
wherein the supply unit supplies a key for decrypting the document together with the restraint information set for the document.

8. The information supply apparatus according to claim 2,
wherein the document has been encrypted, and
wherein the supply unit supplies a key for decrypting the document together with the restraint information set for the document.

9. The information supply apparatus according to claim 3,
wherein the document has been encrypted, and
wherein the supply unit supplies a key for decrypting the document together with the restraint information set for the document.

10. The information supply apparatus according to claim 4,
wherein the document has been encrypted, and
wherein the supply unit supplies a key for decrypting the document together with the restraint information set for the document.

11. The information supply apparatus according to claim 5,
wherein the document has been encrypted, and
wherein the supply unit supplies a key for decrypting the document together with the restraint information set for the document.

12. The information supply apparatus according to claim 6,
wherein the document has been encrypted, and
wherein the supply unit supplies a key for decrypting the document together with the restraint information set for the document.

13. An operation terminal comprising:
a request unit that transmits, to an information supply apparatus, a request for restraint information indicating restraint on an operation among operations performed on a document that has been encrypted;
an acquisition unit that acquires the restraint information supplied from the information supply apparatus in response to the request from the request unit;
a reception unit that receives, among the operations performed on the document, an operation that is not restrained in the restraint information acquired by the acquisition unit; and
a decryption unit that decrypts the document in a case where the operation received by the reception unit needs decryption of the document.

14. The operation terminal according to claim 13,
wherein the acquisition unit acquires a key for decrypting the document together with the restraint information set for the document, and
wherein the decryption unit decrypts the document by using the key acquired by the acquisition unit.

15. An information processing system comprising:
an information supply apparatus; and
an operation terminal,
the information supply apparatus including
a registration unit that registers a first document and a second document in a database in association with each other when the second document is derived from the first document,
a setting unit that refers to the database and sets restraint information indicating restraint on an operation performed on the second document, in accordance with restraint information set for the first document, and
a supply unit that supplies, in a case where the operation terminal transmits a request for restraint information indicating restraint on an operation among operations performed on a document, the operation terminal with the restraint information set for the document by the setting unit,
the operation terminal including
a request unit that transmits, to the information supply apparatus, the request for the restraint information,
an acquisition unit that acquires the restraint information supplied from the information supply apparatus in response to the request from the request unit,
a reception unit that receives, among the operations performed on the document, an operation that is not restrained in the restraint information acquired by the acquisition unit, and
an execution unit that executes information processing on the document in accordance with the operation received by the reception unit.

16. A non-transitory computer readable medium storing a program causing a computer to execute a process comprising:
transmitting, to an information supply apparatus, a request for restraint information indicating restraint on an operation among operations performed on a document that has been encrypted;
acquiring the restraint information supplied from the information supply apparatus in response to the request;
receiving, among the operations performed on the document, an operation that is not restrained in the acquired restraint information; and
decrypting the document in a case where the received operation needs decryption of the document.

17. A non-transitory computer readable medium storing a program causing a computer to execute a process comprising:
registering a first document and a second document in a database in association with each other when the second document is derived from the first document;
referring to the database and setting restraint information indicating restraint on one or more operations among operations performed on the second document, in accordance with restraint information set for the first document; and
supplying, in a case where an operation terminal transmits a request for restraint information indicating restraint on an operation performed on a document, the operation terminal with the restraint information set for the document, the operation terminal restraining, in accordance with the restraint information, the operation performed on the document.
